(19) United States
(12) Patent Application Publication
(10) Pub. No.: US 2006/0002640 A1
(43) Pub. Date: Jan. 5, 2006

(54) Composite dynamic bearing assembly and manufacturing method thereof

(75) Inventors: Lee-Long Chen, Taoyuan Hsien (TW); Chien-Hsiung Huang, Taoyuan Hsien (TW); Shih-Ming Huang, Taoyuan Hsien (TW); Wen-Shi Huang, Toayuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/155,471

(22) Filed: Jun. 20, 2005

(30) Foreign Application Priority Data
Jun. 30, 2004 (TW) 93119406

(51) Int. Cl. F16C 32/06

(52) U.S. Cl. 384/100

(57) ABSTRACT

A composite dynamic bearing assembly and manufacturing method thereof. The composite dynamic bearing assembly includes a bearing bracket and a bearing. The bearing bracket comprises an internal space. The bearing, disposed in the internal space of the bearing bracket, includes a plurality of bearing blocks. Each bearing block has a surface and a plurality of grooves. The surfaces of adjacent bearing blocks fit together tightly to fix the bearing blocks. A plurality of grooves thereof can accommodate lubricant on an inner surface of the bearing after the bearing blocks are combined.

### BACKGROUND

The invention relates to a dynamic bearing, and in particular to a composite dynamic bearing assembly and manufacturing method thereof.

In recent years, most electronic devices and elements such as motors or fans are miniature so that the sizes of internal components thereof are reduced accordingly. Moreover, high rotational accuracy of the bearing is also required.

A dynamic bearing is a compact and highly accurate bearing device. As shown in FIGS. 1A and 1B, the dynamic bearing comprises a bearing bracket 11 and a bearing 12. The bearing bracket 11 comprises an internal space containing the bearing 12. The bearing 12 is a cylinder with an external surface, contacting the bearing bracket 11 and an internal surface with a plurality of grooves 13 formed thereon. A lubricant is disposed in the grooves 13. When the shaft (not shown) rotates, lubricant flows due to shearing stress and dynamic pressure is generated to support and lubricate the shaft.

When manufacturing a dynamic bearing, initially, a bearing is provided. The grooves are then formed on an inner surface of the bearing by engraving. Since minute marking of the grooves is necessary and requires precise measurements within a tiny hollow space, the procedure is difficult. Moreover, the grooves cannot be formed simultaneously with the bearing, thus an additional manufacturing step is required. Hence the cost of manufacturing dynamic bearings is higher than other types of bearings, and manufacturing completely results in reduced yield.

Thus, an improved design is necessary to solve the above-mentioned problem.

### SUMMARY

Embodiments of the invention provide a composite dynamic bearing assembly comprising a bearing bracket and a bearing. The bearing bracket comprises an internal space. The bearing, disposed in the internal space of the bearing bracket, comprises a plurality of bearing blocks. Each bearing block comprises a surface and a plurality of grooves. The surfaces of adjacent bearing blocks are shaped corresponding to each other and fit together tightly such that an interior side of the bearing bracket closely holds the bearing blocks together through contact therebetween. The bearing blocks are provided with the grooves for accommodating lubricant on an inner surface of the bearing after the bearing blocks are combined.

Embodiments of the invention further provide a method of manufacturing a composite dynamic bearing assembly. The method includes the following steps. A bearing bracket comprising an internal space is provided. A plurality of bearing blocks of the identical shape and size are formed. The bearing blocks are then combined to form a bearing. The bearing is disposed in an internal space of the bearing bracket. When combining the bearing blocks, surfaces of adjacent bearing blocks fit together tightly and fix the bearing blocks. When the bearing is disposed in the internal space of the bearing bracket, an external surface of the bearing closely contacts the bearing bracket, holding the bearing blocks together. That is, an interior side of the bearing bracket closely holds the bearing blocks together through contact therebetween. The bearing blocks comprise a plurality of grooves. When combined, the grooves of the bearing blocks accommodate lubricant on the inner surface of the bearing.

### BRIEF DESCRIPTION OF THE DRAWINGS

Embodiments of the invention can be more fully understood by reading the subsequent detailed description in conjunction with the examples and references made to the accompanying drawings, wherein:

FIG. 1A is a schematic perspective view of a conventional dynamic bearing;

FIG. 1B is an unfolded view of the interior side of the dynamic bearing of FIG. 1A;

FIG. 2A is a perspective view of a composite dynamic bearing assembly of a first embodiment of the invention after assembly;

FIG. 2B is an unfolded view of the interior side of individual bearing blocks of the composite dynamic bearing assembly in FIG. 2A;

FIG. 3A is a perspective view of a composite dynamic bearing assembly of a second embodiment of the invention after assembly;

FIG. 3B is an unfolded view of the interior side of individual bearing blocks of the composite dynamic bearing assembly in FIG. 3A; and

FIG. 4 is a flowchart showing a manufacturing method of a composite dynamic bearing assembly of embodiments of the invention.

### DETAILED DESCRIPTION

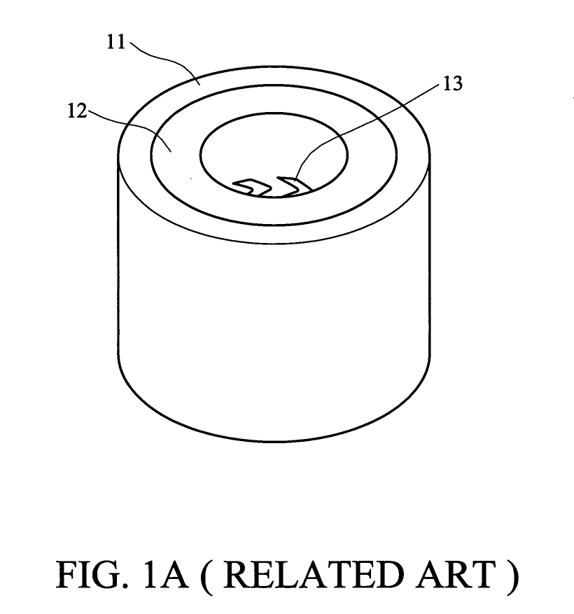

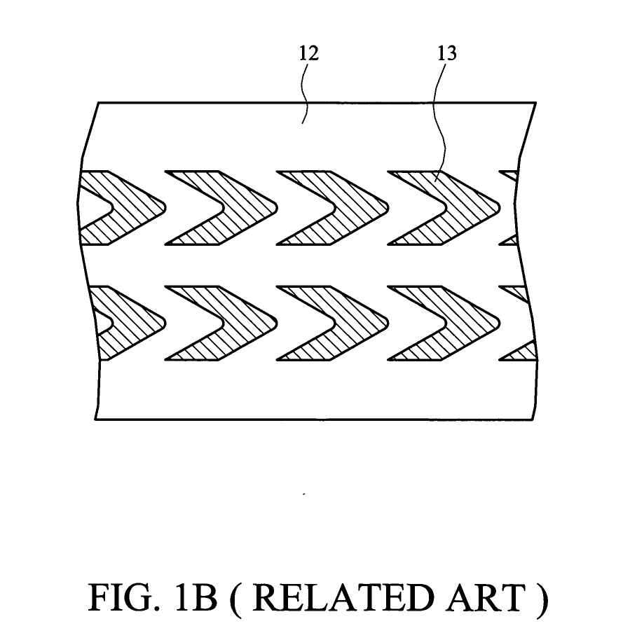

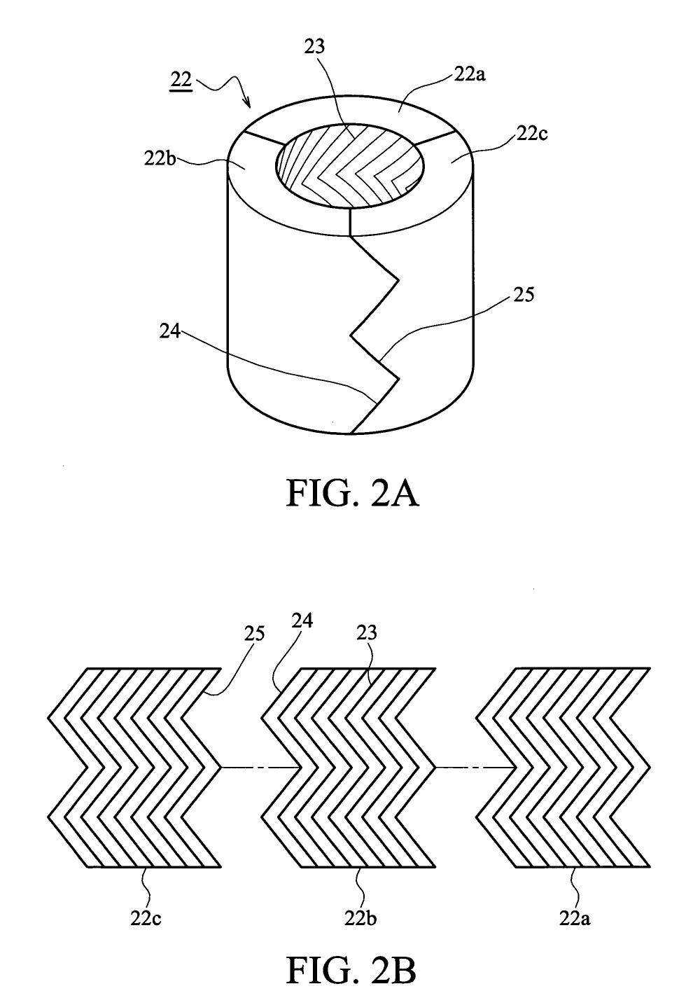

FIG. 2A is a perspective view of a composite dynamic bearing assembly of a first embodiment of the invention after assembly. Common elements described in embodiments subsequent to the first embodiment share the same symbols. Bearing bracket 11, shown in FIG. 1A, is common to all described embodiments of the invention. Note that depiction of a bearing bracket is omitted in FIG. 2A to clearly illustrate a bearing of the first embodiment.

FIG. 2B is an unfolded view of the interior side of individual bearing blocks of the composite dynamic bearing assembly in FIG. 2A. Note that in FIG. 2B, the bearing 22 is cut open and unfolded to show the grooves 23 on an interior side thereof. As shown in FIGS. 2A and 2B, the bearing 22 comprises three curved bearing blocks 22a, 22b, 22c of the identical shape and size. Connecting surfaces 24, 25 of the bearing blocks 22a, 22b, and 22c correspond to each other and tightly connected. For example, the connecting surface 24 of the bearing block 22b and the connecting surface 25 of the bearing block 22c are complementary. In this case, connecting surfaces 24, 25 have a toothed shape or chevron pattern. The bearing blocks 22a, 22b, 22c are combined to form a cylindrical bearing 22 and disposed in an internal space of the bearing bracket (not shown). When the bearing 22 is disposed in the internal space of the bearing bracket, an external surface of the bearing 22 closely contacts the bearing bracket, holding the bearing blocks 22a, 22b, and 22c together. That is, an interior side of the bearing bracket closely holds the bearing blocks 22a, 22b, and 22c together through contact therebetween.

A plurality of grooves 23 with identical patterns are defined on an internal surface of each bearing block 22a, 22b, and 22c. The pattern of the grooves 23 can be identical to or different from the shapes of the connecting surfaces 24, 25. Thus, after combination of the bearing blocks 22a, 22b, 22c, grooves 23 can accommodate lubricant on the inner surface of the bearing 22.

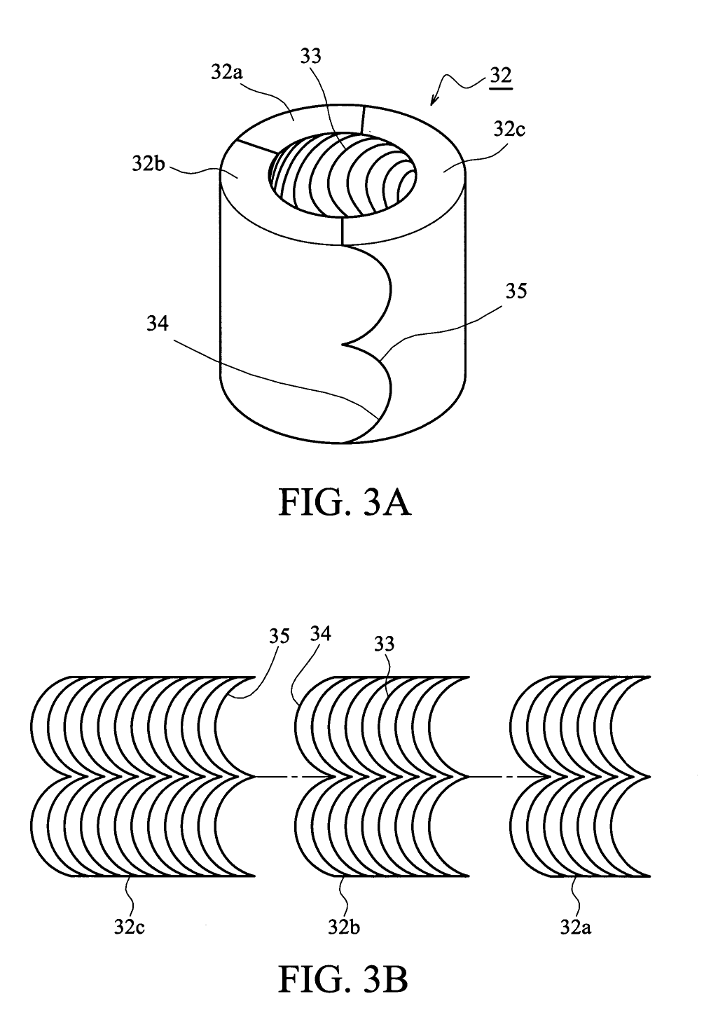

The quantity, size, and shape of bearing blocks and groove patterns, and combination thereof are given here as an example of one possible arrangement. Embodiments can be varied according to demands. For example, as shown in FIGS. 3A and 3B, the bearing 32 comprises three bearing blocks 32a, 32b, and 32c with similar shapes but different sizes. The connecting surfaces 34 and 35 and the grooves 33 of the bearing blocks 32a, 32b, 32c are both curved.

Alternatively, the connecting surfaces 34 and 35 of the bearing blocks 32a, 32b, 32c are curved, but the grooves 33 can have a chevron pattern (not shown). Although not mentioned here other combinations are possible.

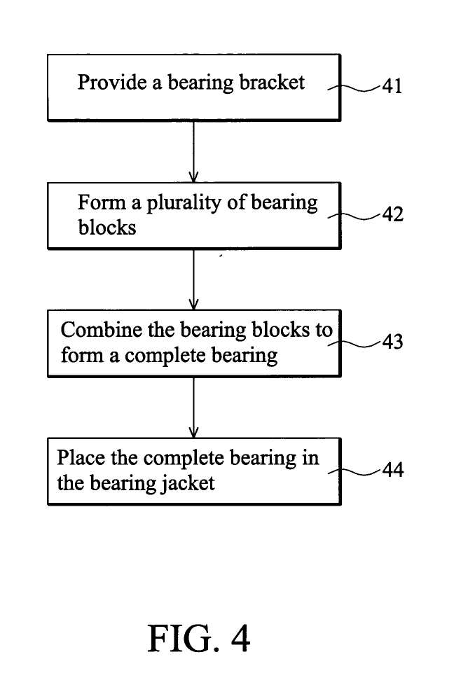

FIG. 4 is a flowchart showing a manufacturing method of a composite dynamic bearing assembly of embodiments of the invention. In step 41, a bearing bracket comprising an internal space is provided. In step 42, a plurality of bearing blocks are formed. The shape and size of the bearing blocks are designed such that they can be combined to form a bearing (step 43). When the bearing blocks are combined, surfaces of adjacent bearing blocks fit together tightly and fix the bearing blocks. The bearing is disposed in an internal space of the bearing bracket. When the bearing is disposed in the internal space of the bearing bracket, contact from an external surface of the bearing holds the bearing blocks. During formation of the bearing blocks, a plurality of grooves can be simultaneously formed on an internal surface of each bearing block. Thus, after combination of the bearing blocks, the grooves can accommodate lubricant on the inner surface of the bearing.

Furthermore, as mentioned, in step 43, the bearing blocks are combined to form the bearing. In step 44, the bearing formed by bearing blocks is placed in the internal space of the bearing bracket, thereby producing a composite dynamic bearing assembly. The contact between the external surface of the bearing and the bearing bracket securely hold the bearing blocks together. Thus, an additional step of gluing or engaging the bearing blocks is unnecessary.

In step 42, the bearing blocks can be formed by casting, molding, or similar methods. The number, size, shape, combination type, patterns of the grooves depend on practical demands. If the bearing is required to be cylindrical, the bearing blocks can be curved blocks and combined in a radial direction of the bearing. Furthermore, to increase production capacity, the shapes and sizes of the bearing blocks can be identical, and formed by the same mold. The shape of the grooves, depends on the requirements of the grooves. In one embodiment, the shapes of the grooves and each connecting surface of each bearing block are identical.

In conclusion, the bearing of embodiments of the invention is formed by a plurality of bearing blocks. When manufacturing each bearing block, the grooves are formed thereon simultaneously. Compared with conventional designs, the manufacturing method of the invention is simpler. Furthermore, the grooves are formed in an open space, rather than in a narrow, confined space. Thus, manufacturing the grooves is easier.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A composite dynamic bearing assembly, comprising:
a bearing bracket; and
a bearing, disposed in the bearing bracket, and comprising a plurality of bearing blocks, each of which has a surface and a plurality of grooves, wherein connecting surfaces of adjacent bearing blocks are shaped corresponding to each other and fit tightly together.

2. The composite dynamic bearing assembly as claimed in claim 1, wherein the bearing bracket comprise an internal space to hold the bearing blocks together therein.

3. The composite dynamic bearing assembly as claimed in claim 1, wherein the bearing blocks are curved, and the bearing blocks are combined in a radial direction of the bearing to form a cylindrical bearing.

4. The composite dynamic bearing assembly as claimed in claim 3, wherein the bearing blocks have similar size and shape.

5. The composite dynamic bearing assembly as claimed in claim 4, wherein the bearing blocks have identical size and shape.

6. The composite dynamic bearing assembly as claimed in claim 4, wherein the connecting surfaces of the bearing blocks have a toothed shape.

7. The composite dynamic bearing assembly as claimed in claim 4, wherein the connecting surfaces of the bearing blocks are curved.

8. The composite dynamic bearing assembly as claimed in claim 4, wherein the grooves of the bearing blocks correspond to the shapes of the connecting surfaces such that the grooves on the inner surface of the bearing are distributed uniformly.

9. The composite dynamic bearing assembly as claimed in claim 4, wherein the grooves have a chevron pattern.

10. The composite dynamic bearing assembly as claimed in claim 4, wherein the grooves have a curved pattern.

11. A manufacturing method of a composite dynamic bearing assembly, comprising the steps of:
providing a bearing bracket; and
forming a plurality of bearing blocks wherein connecting surfaces of adjacent bearing blocks are shaped corresponding to each other and fit tightly together, and a plurality of grooves formed on an inner surface of each bearing blocks;
combining the bearing blocks to form a bearing; and
placing the bearing in the bearing bracket.

12. The method as claimed in claim 11, wherein the bearing bracket comprise an internal space to hold the bearing blocks together therein.

13. The method as claimed in claim 11, wherein the bearing blocks are curved, and the bearing blocks are combined in a radial direction of the bearing to form a cylindrical bearing.

14. The method as claimed in claim 13, wherein the bearing blocks have similar size and shape.

15. The method as claimed in claim 14, wherein the bearing blocks have identical size and shape.

16. The method as claimed in claim 14, wherein the connecting surfaces of the bearing blocks have a toothed shape.

17. The method as claimed in claim 14, wherein the connecting surfaces of the bearing blocks are curved.

18. The method as claimed in claim 14, wherein the grooves of the bearing blocks have the same patterns as the shapes of the connecting surfaces such that the grooves on the inner surface of the bearing are distributed uniformly.

19. The method as claimed in claim 14, wherein the grooves have a chevron pattern.

20. The method as claimed in claim 14, wherein the grooves have a curved pattern.

21. The method as claimed in claim 9, wherein the bearing blocks are formed by casting and molding.

22. The method as claimed in claim 9, wherein the bearing blocks are integrally formed.
